(19) United States
(12) Patent Application Publication
(10) Pub. No.: US 2013/0346695 A1
(43) Pub. Date: Dec. 26, 2013

(54) INTEGRATED CIRCUIT WITH HIGH RELIABILITY CACHE CONTROLLER AND METHOD THEREFOR

(71) Applicants: Gabriel H. Loh, Bellevue, WA (US); Vilas Sridharan, Brookline, MA (US)

(72) Inventors: Gabriel H. Loh, Bellevue, WA (US); Vilas Sridharan, Brookline, MA (US)

(73) Assignee: ADVANCED MICRO DEVICES, INC., Sunnyvale, CA (US)

(21) Appl. No.: 13/532,125

(22) Filed: Jun. 25, 2012

(51) Int. Cl. G06F 12/08

(52) U.S. Cl. 711/122; 711/E12.024

(57) ABSTRACT

An integrated circuit includes a register including a field for defining a high reliability mode of the integrated circuit and a cache and memory controller coupled to the register and responsive to the high reliability mode to access a memory to store, in a row of the memory, a first multiple number of cache lines, a first multiple number of tags corresponding to the first multiple number of cache lines, and reliability data corresponding to at least the first multiple number of cache lines.

Related subject matter is found in a copending patent application entitled “A DRAM Cache With Tags and Data Jointly Stored In Physical Rows”, U.S. patent application Ser. No. 13/307,776, filed Nov. 30, 2011, invented by Gabriel H. Loh et al. and assigned to the assignee hereof.

### FIELD

This disclosure relates generally to computer systems, and more specifically to integrated circuits for computer systems having cache controllers.

### BACKGROUND

Consumers continue to demand computer systems with higher performance and lower cost. To address higher and higher performance requirements, computer chip designers have developed integrated circuits with multiple processor cores using a cache memory hierarchy on a single chip. The on-chip caches increase overall performance by reducing the average time required to access frequently used instructions and data. Higher level (“L1”) and (“L2”) caches in the cache hierarchy are generally implemented on the same integrated circuit as the multiple cores and are placed operationally close to the processor cores. Typically, each core accesses its own dedicated L1 cache, while an L2 cache is shared between multiple cores. A next level (“L3”) cache may be the last level cache in the system and may be implemented with an integrated cache controller and off-chip memory.

Continued performance and system cost pressure has led to increasing requirements for inexpensive high performance memory technology. Since all of the cache memory cannot be realistically placed on the same integrated circuit as the processor cores, requirements for additional external “last level” cache memory continues to increase. Addressing both performance and system cost, various die stacked integration technologies have been developed that package the multi-core integrated microprocessor and associated memory chips as a single component. However memory chips are susceptible to various fault conditions. In the case of memory chips used in stacked die configurations, when a permanent fault occurs, it is not possible to easily replace the memory chip without replacing all other chips in the stack.

### BRIEF DESCRIPTION OF THE DRAWINGS

FIG. 1 illustrates a perspective view of a first multi-chip module implementing a cache.

FIG. 2 illustrates a perspective view of a second multi-chip module implementing a cache.

FIG. 3 illustrates in block diagram form a computer system that supports a high reliability mode according to the present invention.

FIG. 4 illustrates in block diagram form a portion of a memory used as cache memory in a normal mode including an exemplary row.

FIG. 5 illustrates in block diagram form a portion of a memory used as cache memory in a high reliability mode including the exemplary row.

In the following description, the use of the same reference numerals in different drawings indicates similar or identical items.

### DETAILED DESCRIPTION OF ILLUSTRATIVE EMBODIMENTS

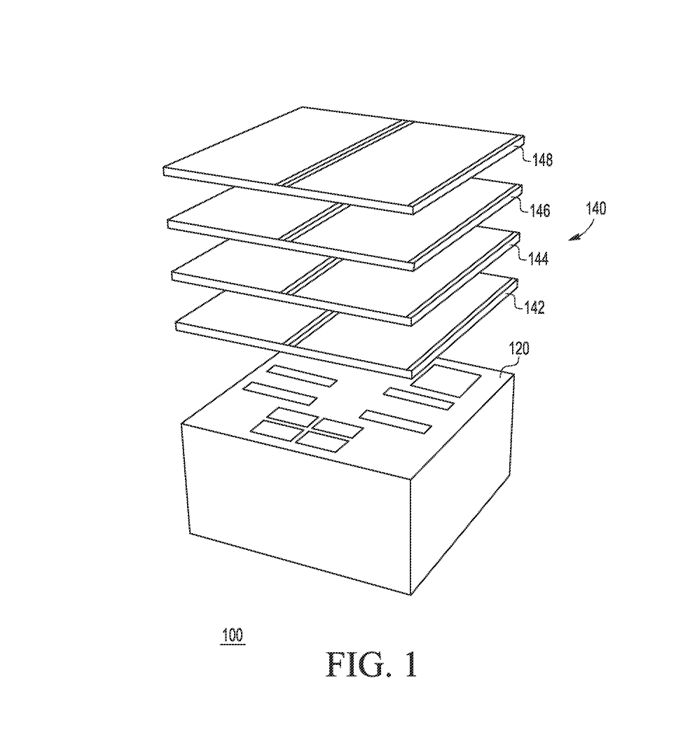

FIG. 1 illustrates a perspective view of a first multi-chip module 100 implementing a cache. Multi-chip module 100 generally includes a multi-core processor chip 120 and a memory chip stack 140. Memory chip stack 140 generally includes a memory chip 142, a memory chip 144, a memory chip 146, and a memory chip 148. Each individual memory chip of memory chip stack 140 is connected to other memory chips of memory chip stack 140, as required for proper system operation. Also, each individual memory chip of memory chip stack 140 connects to multi-core chip 120, as required, for proper system operation.

In operation, the components of multi-chip module 100 are combined in a single integrated circuit package, where memory chip stack 140 and multi-core chip 120 appear to the user as a single integrated circuit. Electrical connection of memory chip stack 140 to multi-core chip 120 is accomplished using vertical interconnect, for example, a via or silicon through hole, in combination with horizontal interconnect. Multi-core processor die 120 is thicker than memory chips in memory chip stack 140 and physically supports memory chip stack 140. In one embodiment, memory chip stack 140 provides the memory for a last level of cache within a cache hierarchy, e.g., a level 3 (“L3”) cache. When compared to five individual chips, multi-chip module 100 saves system cost and board space, while decreasing component access time and increasing system performance in general. However the memory chips are subject to various reliability issues. For example, background radiation, such as alpha particles occurring naturally in the environment or emitted from semiconductor packaging material can strike a bit cell, causing the value to be corrupted. Also repeated use of the memory can lead to other failures.

For example, electromigration in certain important wires could lead those wires to wear out: they effectively become thinner, thereby increasing their resistance and eventually leading to timing errors that cause incorrect values to be read. Other types of faults are also possible. If a memory chip fails, there's no practical way to replace the failing memory chip. Instead, the user must replace the entire package, including all of the still working memory and processor chips, which is an expensive option.

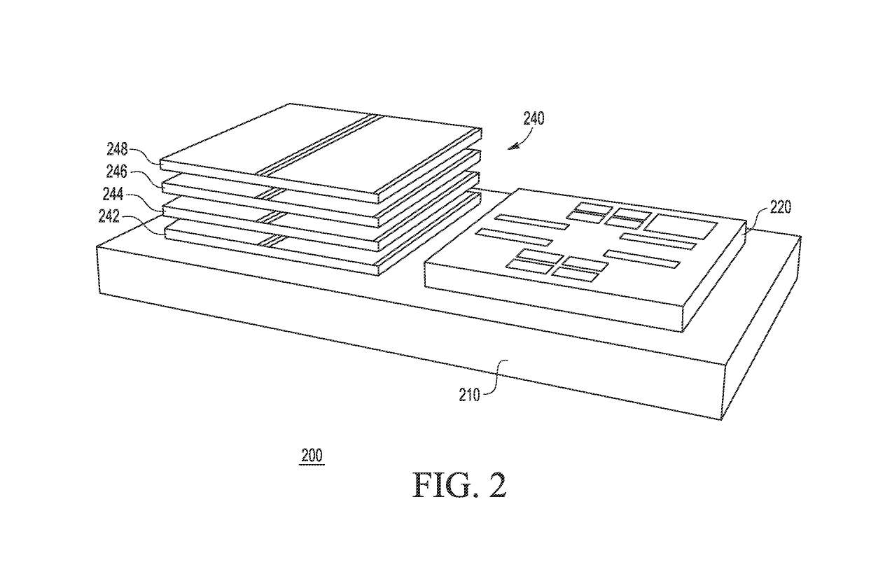

FIG. 2 illustrates a perspective view of a second multi-chip module 200 implementing a cache. Multi-chip module 200 generally includes an interposer 210, a multi-core processor chip 220, and a memory chip stack 240. Interposer 210 is connected to the active side of multi-core chip 220. Memory chip stack 240 generally includes memory chip 242, memory chip 244, memory chip 246, and memory chip 248. Each individual memory chip of memory chip stack 240 is connected to other memory chips of memory chip stack 240, as required for proper system operation. Also, each individual memory chip of memory chip stack 240 is connected to multi-core chip 220, as required for proper system operation.

In operation, the components of multi-chip module 200 are combined in a single package (not shown in FIG. 2), and thus memory chip stack 240 and multi-core chip 220 appear to the user as a single integrated circuit. Electrical connection of memory chip stack 240 to multi-core chip 220 is accomplished using vertical interconnect, for example, a via or silicon through hole, in combination with horizontal interconnect. Interposer 210 provides both a physical support and an interface to facilitate connecting each individual memory chip of memory chip stack 240 multi-core chip 220. In one embodiment, memory chip stack 240 provides the memory for a last level of cache within a cache hierarchy, e.g., an L3 cache. When compared to five individual chips, multi-chip module 200 saves system cost and board space, while decreasing component access time and increasing system performance in general. Multi-chip module 200 separates memory chip stack 240 from multi-core processor 220 and so allows better cooling of multi-core processor 220. However, multi-chip module 200 also suffers from reliability and serviceability issues since a defective memory chip cannot be easily replaced without replacing the entire package.

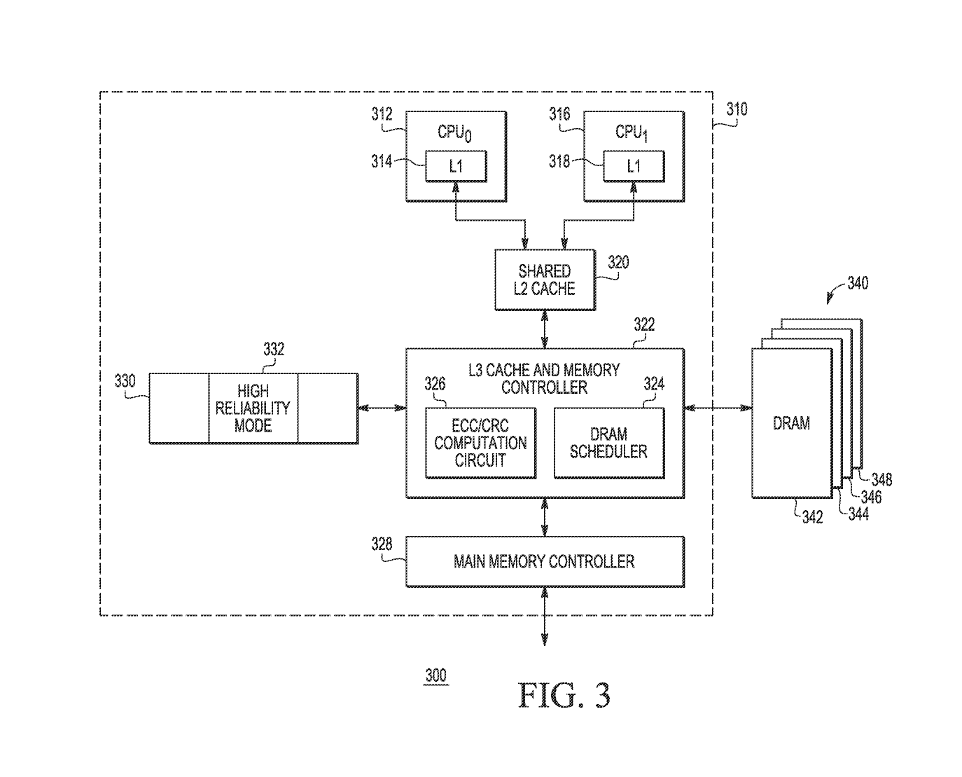

FIG. 3 illustrates in block diagram form a computer system 300 that supports a high reliability mode according to the present invention. Computer system 300 generally includes an accelerated processing unit (APU) 310 and a dynamic random access memory (“DRAM”) memory store 340. APU 310 generally includes a first central processing unit (CPU) core 312 labeled “CPU₀”, a second CPU core 316 labeled “CPU_{I}”, a shared L2 cache 320, an L3 cache and memory controller 322, a main memory controller 328, and a register 330. CPU core 312 includes an L1 cache 314 and CPU core 316 includes an L1 cache 318. DRAM memory store 340 generally includes low power, high-speed operation DRAM chips, including a DRAM chip 342, a DRAM chip 344, a DRAM chip 346, and a DRAM chip 348. DRAM memory store 340 uses commercially available DRAM chips such as double data rate (“DDR”) SDRAMs.

Register 330 includes a high reliability mode field 332 to indicate whether L3 cache and memory controller 322 is in a high reliability mode or a normal mode. Register 330 is any circuit that indicates the mode, and may be implemented in a variety of ways, including as a fuse block for statically configuring L3 cache and memory controller 322 at boot-up, a memory location, a model specific register, and a static register to store a value of an external configuration signal. L3 cache and memory controller 322 includes an error correction code (“ECC”)/cyclic redundancy code (“CRC”) computation circuit 326, and a DRAM scheduler 324.

CPU core 312 has a bidirectional port connected to a first bidirectional port of shared L2 cache 320, over a bidirectional bus. CPU core 316 has a bidirectional port connected to a second bidirectional port of shared L2 cache 320, over a bidirectional bus. Shared L2 cache 320 has a third bidirectional port connected to a first bidirectional port of L3 cache and memory controller 322, over a bidirectional bus. L3 cache and memory controller 322 has a third bidirectional port connected to a bidirectional port of DRAM memory store 340 over a bidirectional bus. L3 cache and memory controller 322 has a fourth bidirectional port connected to a first bidirectional port of main memory controller 328 over a bidirectional bus. Main memory controller 328 has a second bidirectional port connected to main memory over a bidirectional bus. Register 330 has a bidirectional port connected to a second bidirectional port of L3 cache and memory controller 322, over a bidirectional bus.

In operation, CPU core 312 and CPU core 316 each have the capability to execute an instruction set including instructions requiring access to data associated with the instructions. L1 cache 314 and L cache 318 each represent the first cache accessed by CPU core 312 and CPU core 316, respectively, when an instruction or block of data is accessed. In APU 310, L1 caches 314 and 318 each include separate instruction and data caches. L1 cache 314 and L1 cache 318 each include memory to store recently accessed data. L1 cache 314 and L1 cache 318 are each characterized as the L1 cache of the cache hierarchy of computer system 300, since L1 cache 314 is operationally closest to CPU core 312 and L cache 318 is operationally closest to CPU core 316. CPU core 312 accesses L cache 314 and CPU core 316 accesses L1 cache 318 to determine whether the accessed cache line has been allocated to the cache before accessing the next lower level of the cache hierarchy.

For example, if CPU core 312 needs to perform a read or write access, it checks L1 cache 314 first to see whether L cache 314 has allocated a cache line corresponding to the access address. If the cache line is present in L1 cache 314 (i.e. the access “hits” in L1 cache 314), CPU core 312 completes the access with L1 cache 314. If the access misses in L1 cache 314, L1 cache 314 checks shared L2 cache 320, since shared L2 cache 320 is the next lower level of the memory hierarchy. Likewise, if the address of the request does not match any cache entries, shared L2 cache 320 will indicate a cache miss. Following the cache miss, shared L2 cache 320 will check the L3 cache, since the L3 cache is the next lower level of the memory hierarchy. If the requested data is not found in the cache hierarchy, the last level of the cache hierarchy will write or read the data to or from main memory. During a check of the memory hierarchy, if the requested data is found, the corresponding cache indicates a cache hit and provides the new data to the requesting CPU core cache client. Using a predetermined replacement policy, a selected cache will evict existing data to make room in the cache hierarchy for the new data.

L3 cache and memory controller 322 responds to the state of high reliability mode field 332 by operating DRAM memory store 340 in either a normal mode or a high reliability mode. In the high reliability mode, L3 cache and memory controller 322 stores a first multiple number of cache lines, a first multiple number of tags corresponding to the first multiple number of cache lines and reliability data in a selected row of DRAM memory store 340. In the normal mode, L3 cache and memory controller 322 stores a second multiple number of cache lines and a second multiple number of tags corresponding to the second multiple number of cache lines in the selected row of DRAM memory store 340. The second multiple number of cache lines in normal mode is typically greater in number than the first multiple number of cache lines in high reliability mode 322. DRAM scheduler 324, in response to an access request from CPU core 312 or CPU core 316 to a row of DRAM memory store 340, activates the selected row and reads at least one of the multiple number of tags to determine whether an address of the access request matches a corresponding one of the multiple number of cache lines.

In the high reliability mode, if L3 cache and memory controller 322 indicates a cache hit, in response, L3 cache and memory controller 322 accesses both the corresponding one of a multiple number of cache lines and the corresponding reliability data before closing the row of DRAM memory store 340. DRAM scheduler 324 advantageously prioritizes the accesses based on their type. In a first example, DRAM scheduler 324 schedules reads to at least one of the multiple number of tags and schedules accesses to a selected one of the multiple number of cache lines at a higher priority than accesses to the reliability data. In a second example, before closing the row of DRAM memory store 340, L3 cache and memory controller 322, when appropriate, corrects the reliability data, or the multiple number of cache lines, and stores updated reliability data and an update of the multiple number of cache lines in DRAM memory store 340. In a third example, L3 cache and memory controller 322 schedules accesses to tags and data elements with a higher priority than ECC related accesses. In a fourth example, L3 cache and memory controller 322 prioritizes a read of tags and data elements, including checking of the corresponding ECC, prior to scheduling a lower priority CRC check and write operation of the corrected data elements back to memory store 340.

DRAM scheduler 324 has the capability to access reliability data from ECC/CRC computation circuit 326. ECC/CRC computation circuit 326 checks a cache line accessed by DRAM scheduler 324 using the reliability data, and if appropriate, selectively corrects errors in either the cache data or tag contents and forwards the corrected data to the requesting CPU. If the error is correctable, DRAM scheduler 324 stores the updated reliability data in the corresponding row of DRAM memory store 340 in response to detecting an error in the corresponding cache line.

Finally, main memory controller 328 accesses system memory (not shown) for data not allocated to any cache in the cache hierarchy.

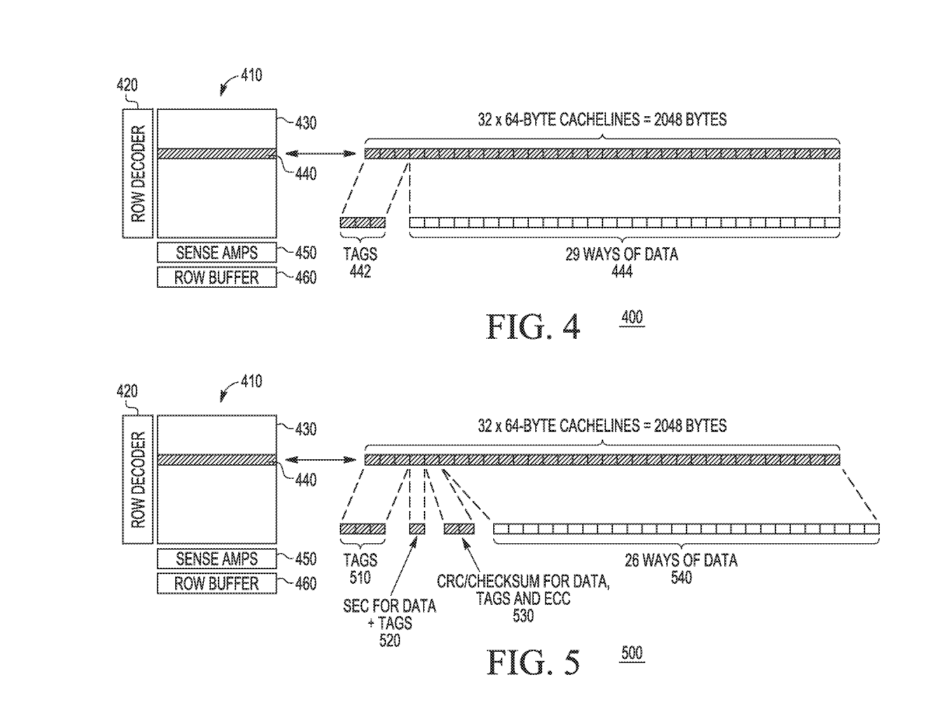

FIG. 4 illustrates in block diagram form a portion of a memory 400 used as cache memory in a normal mode including an exemplary row 440. Memory 400 includes a bank 410 having a row decoder 420, a memory array 430 including multiple rows of data including an exemplary row 440, a set of sense amplifiers (amps) 450, and a row buffer 460. For this example, exemplary row 440 includes 2048 bytes of data which can be organized as 32 ways of 64-byte cache lines. Cache and memory controller 322, however, stores a set of tags 442 and a set of data elements 444 in selected row 440 of memory bank 410. Tags 442 are included in three of the 64-byte units, and data elements 444 are included in the remaining twenty nine 64-byte units.

In operation, cache and memory controller 322 operates memory 400 as a 29-way set-associative cache, using three of the 64-byte units forming a row to store tags. The L3 cache can use inexpensive, off-the-shelf memory chips without needing separate tag memory. For example, most computer memory chips are compatible with one of the double data rate (DDR) standards published by JEDEC, such as DDR3. DDR3 and GDDR5 chips have large memory banks and are not organized to store tags for a set of cache lines. However by dividing each row of a conventional memory bank into a tags section and a data section, cache and memory controller 322 is able to utilize standard, off-the-shelf DRAM chips to form both the tag and data portions of the L3 cache. Thus the L3 cache can be large yet inexpensive. Moreover cache and memory controller 322 is suitable for use in a multi-chip module like multi-chip modules 100 and 200, allowing the benefits of reduced system cost and board space, reduced component access time, and increased system performance while addressing their underlying reliability and serviceability issues.

FIG. 5 illustrates in block diagram form a portion of a memory 500 used as cache memory in a high reliability mode including exemplary row 440. Memory 500 includes memory bank 410 as described above. However in the high reliability mode, cache and memory controller 422 uses exemplary row 440 differently than in memory 400. In memory 500, cache and memory controller 422 organizes rows such as exemplary row 440 into three units containing a set of tags 510, one unit containing a set of single error correction (“SEC”) codes 520 for a set of twenty six data elements 540 and tags 510, and two units containing cyclic redundancy check (CRC)/checksum codes 530 for data elements 540, tags 510, and ECC codes of the corresponding cache lines. Tags 510 are included in three of the 64-byte units, SEC codes 520 are included in one 64-byte unit, CRC/checksum 5 codes 30 are included in two of the 64-byte units, and data elements 540 are included in the remaining twenty six 64-byte units.

In the high reliability mode, cache and memory controller 322 uses a portion of each row of memory 500 as reliability data corresponding to the cache lines. In particular, cache and memory controller 322 forms two reliability codes. The first reliability code is an error correcting code (ECC). Cache and memory controller 322 implements SEC codes to allow single bit errors to be detected and corrected. Cache and memory controller 322 forms each SEC code for both the data in the cache line and its corresponding tag and status bits.

In addition, cache and memory controller 322 generates and stores in exemplary row 440 further reliability data in the form of a checksum, such as a cyclic redundancy check (CRC) code, for each of the data, tags, and ECC code. The CRC code is useful to determine whether, with very high probability, the cache line and all its associated control information, including the ECC bits, are error free. Cache and memory controller 322 calculates the ECC and CRC for a given cache line whenever it is loaded from memory and whenever its contents are altered. On an access to a particular cache line, cache and memory controller 322 fetches the data from DRAM 340 and uses ECC/CRC computation circuit 326 to calculate both the ECC (such as the SEC code as shown in FIG. 5) for the cache line and tags, and the CRC for the cache line, tags, and ECC.

In order to accommodate the additional reliability data in high reliability mode, cache and memory controller 322 reduces the number of available cache lines slightly, and each row stores 26 ways instead of 29 ways. However the added reliability data is useful for some applications, such as those using the multi-chip modules shown in FIGS. 1 and 2. Moreover the ability to select the reliability mode of cache and memory controller 322 according to high reliability mode field 332 improves the flexibility of cache and memory controller 322 for different applications. When accessing memory 340, L3 cache and memory controller 322 reads the ECC bits and the CRC/checksum bits corresponding to a selected way. ECC/CRC computation circuit 326 calculates the reliability data in parallel and compares it with the stored reliability data. If ECC/CRC computation circuit 326 detects a single bit error in the SEC bits, then it corrects the error in the cache line by correcting it and either storing it back to memory 340, forwarding the corrected data to the CPU core through the cache hierarchy, or both. ECC/CRC computation circuit 326 can detect multiple-bit errors, in which case it reports the condition to the CPU core.

Also, additional pluralities of cache lines, including an additional multiple number of tags 510, additional multiple numbers of data elements 540, and additional reliability data, such as SEC 520 for data elements 540 and tags 510. CRC/checksum 530 codes for the corresponding cache lines for data elements 540, tags 510, and ECC (codes) for the corresponding cache lines, are stored in additional rows 440 of memory store 410. Note that the size of each of the tags, data, and reliability data (ECC/CRC) may vary in other embodiments.

While the invention has been described in the context of a preferred embodiment, various modifications will be apparent to those skilled in the art. The high reliability cache controller described herein is useful for other integrated circuit configurations that are susceptible to data corruption besides multi-chip modules 100 and 200. For example, the processor and memory chips may be directly attached to a motherboard substrate using flip-chip bonding. Also the cache controller and memory may be implemented on the same die but for other reasons be susceptible to data corruption, such as by being used in environments with high levels of electromagnetic interference (EMI). Memory chip stack 140 or memory chip stack 240 can be implemented separate from computer system 300 main memory, e.g., as separate CPU memory, separate graphics processing unit (“GPU”) memory, separate APU memory, etc. Die stacking integration 100 and die stacking integration 200 can be implemented as a multi-chip module (“MCM”). Alternately, the memory chips can be placed adjacent to and co-planar with the CPU, GPU, APU, main memory, etc. on a common substrate. Note that while multi-chip modules 100 and 200 include 4-chip memory chip stacks, other embodiments may include different numbers of memory chips.

Also, L3 cache and memory controller 322 can be integrated with at least one processor core on a microprocessor die as shown in FIG. 3, or can be on its own separate chip. Register 330 and L3 cache and memory controller 322 can be formed on a first semiconductor die. Memory store 340 can include at least one additional semiconductor die. Register 330, L3 cache and memory controller 322, and memory store 340 can be formed on a common semiconductor die. L3 cache and memory controller 322 can generate each of the multiple number of CRCs 530 for a corresponding one of the first multiple number of cache lines, a corresponding one of the multiple number of tags 510, and a corresponding ECC.

Also, the reliability data can include a corresponding first multiple number of ECCs for at least each of the first multiple number of cache lines. The reliability data can include a multiple number of CRCs 530 for at least each of the first multiple number of cache lines.

Other examples of reliability data include parity bits, error correcting code bits {e.g., including but not limited to single error correction (“SEC”), single error correction and double error detection (“SEC-DED”), double bit error correction and triple bit error detection (“DEC-TED”), triple-error-correct, quad-error-detect (“TEC-QED”) and linear block codes such as Bose Chaudhuri Hocquenghem (“BCH”) codes} and checksums. Support for one, two, or more levels of ECC protection can be provided, where the system hardware or software can make selections to balance performance and reliability needs.

Note that system 300 illustrates the high reliability mode at the L3 level of the cache hierarchy. However in other embodiments, the high reliability mode may be implemented at any level, or at multiple levels, of the cache hierarchy.

Also, memory store 340 has been described above as DRAM technology. However, memory store 340 can be implemented with other memory technologies, for example static random access memory (“SRAM”), phase-change memory (“PCM”), resistive RAM technologies such as memristors and spin-torque transfer magnetic RAM (“STT-MRAM”), and Flash memory.

Accordingly, it is intended by the appended claims to cover all modifications of the invention that fall within the true scope of the invention.

What is claimed is:

1. An integrated circuit, comprising:
a register including a field for defining a high reliability mode of the integrated circuit; and
a cache and memory controller coupled to said register and responsive to said high reliability mode to access a memory to store, in a row of said memory, a first plurality of cache lines, a first plurality of tags corresponding to said first plurality of cache lines, and reliability data corresponding to at least said first plurality of cache lines.

2. The integrated circuit of claim 1 wherein:
said field further defines a normal mode of the integrated circuit; and
said cache and memory controller is further responsive to said normal mode to access said memory to store, in said row of said memory, a second plurality of cache lines and a second plurality of tags corresponding to said second plurality of cache lines, wherein said second plurality of cache lines is greater in number than said first plurality of cache lines.

3. The integrated circuit of claim 1 wherein said register comprises at least one of: a hardware register, a fuse block, and a memory location.

4. The integrated circuit of claim 3 wherein said register comprises a model specific register.

5. The integrated circuit of claim 3 wherein said register comprises a static register for storing a value of an external configuration signal.

6. The integrated circuit of claim 1 wherein said cache and memory controller and said memory together form a level 3 (L3) cache in a cache hierarchy.

7. The integrated circuit of claim 1 wherein said cache and memory controller is integrated with at least one processor core on a microprocessor die.

8. The integrated circuit of claim 1 wherein said register and said cache and memory controller are formed on a first semiconductor die, and said memory includes at least one additional semiconductor die.

9. The integrated circuit of claim 1 wherein said at least one additional semiconductor die comprises a plurality of memory chips in a memory chip stack.

10. The integrated circuit of claim 1 wherein said reliability data comprises a corresponding first plurality of error correcting codes (ECCs) for at least each of said first plurality of cache lines.

11. The integrated circuit of claim 1 wherein said reliability data comprises a plurality of cyclic redundancy check (CRC) codes for at least each of said first plurality of cache lines.

12. The integrated circuit of claim 11 wherein said cache and memory controller generates each of said plurality of cyclic redundancy check (CRC) codes for a corresponding one of said first plurality of cache lines, a corresponding one of said plurality of tags, and a corresponding error correcting code (ECC).

13. An integrated circuit, comprising:
a register including a field for selectively enabling a high reliability mode of the integrated circuit; and
a cache and memory controller coupled to said register, and responsive to said high reliability mode to operate a memory to store, in a row of said memory, a plurality of cache lines, a plurality of tags, and reliability data corresponding to at least said plurality of cache lines in said high reliability mode, said cache and memory controller comprising a scheduler that, in response to an access request to said row of said memory, activates said row and reads at least one of said plurality of tags to determine whether an address of said access request matches a corresponding one of said plurality of cache lines, and in response to a cache hit accesses both said corresponding one of said plurality of cache lines and said reliability data before closing said row of said memory.

14. The integrated circuit of claim 13 wherein said cache and memory controller checks said corresponding one of said plurality of cache lines using said reliability data, and selectively corrects said corresponding one of said plurality of cache lines in response to detecting an error.

15. The integrated circuit of claim 13 wherein said cache and memory controller is integrated with at least one processor core on a microprocessor die.

16. The integrated circuit of claim 13 wherein said register and said cache and memory controller are formed on a first semiconductor die, and said memory includes at least one additional semiconductor die.

17. The integrated circuit of claim 13 wherein said reliability data comprises a plurality of error correcting codes (ECCs) each for at least a corresponding one of said plurality of cache lines.

18. The integrated circuit of claim 13 wherein said reliability data comprises a plurality of cyclic redundancy check (CRC) codes each for at least a corresponding one of said plurality of cache lines.

19. An integrated circuit, comprising:
a register including a field for selectively enabling a high reliability mode of the integrated circuit; and
a cache and memory controller coupled to said register and responsive to said high reliability mode to operate a memory to store, in a row of said memory, a plurality of cache lines, a plurality of tags, and reliability data corresponding to at least said plurality of cache lines in said high reliability mode, said cache and memory controller comprising a scheduler that, in response to an access request to said row of said memory, schedules reads to at least one of said plurality of tags and accesses to a selected one of said plurality of cache lines at a higher priority than accesses to said reliability data.

20. The integrated circuit of claim 19 wherein said reliability data comprises a plurality of error correcting codes (ECCs) each for at least a corresponding one of said plurality of cache lines.

21. The integrated circuit of claim 20 wherein said reliability data comprises a cyclic redundancy check (CRC) code each for at least said plurality of cache lines.

22. The integrated circuit of claim 21 wherein said scheduler schedules an access to said plurality of CRC codes at a lower priority than accesses to said plurality of ECCs.

23. The integrated circuit of claim 19 wherein said register and said cache and memory controller are formed on a first semiconductor die, and said memory includes at least one additional semiconductor die.

24. A method comprising:
storing in a first row of a memory a first plurality of cache lines, a first plurality of tags corresponding to said first plurality of cache lines, and reliability data corresponding to at least said first plurality of cache lines in a high reliability mode;
accessing at least one of said plurality of tags to determine whether a corresponding one of said first plurality of cache lines matches a corresponding address field of an access request; and
if said corresponding one of said plurality of cache lines matches said corresponding address field of said access request, using said reliability data to check whether said data in said corresponding one of said first plurality of cache lines has an error.

25. The method of claim 24 further comprising:
storing in a second row of a memory a second plurality of cache lines and a second plurality of tags corresponding to said plurality of cache lines in a normal mode, wherein said second plurality is greater in number than said first plurality.

26. The method of claim 24 further comprising:
storing in said first row of said memory cache status bits for said first plurality of cache lines.

27. The method of claim 24 wherein said storing said reliability data comprises:
storing a plurality of error correcting codes (ECCs) each for at least a corresponding one of said first plurality of cache lines.

28. The method of claim 24 further comprising:
storing a plurality of cyclic redundancy check (CRC) codes for at least each of said first plurality of cache lines.

29. The method of claim 28 further comprising:
storing said plurality of cyclic redundancy check (CRC) codes for a corresponding one of said first plurality of cache lines, a corresponding one of said plurality of tags, and a corresponding error correcting code (ECC).

30. The method of claim 24 further comprising:
storing in additional rows of said memory additional pluralities of cache lines, tags, and corresponding reliability data.
